(19) United States
(12) Patent Application Publication
(10) Pub. No.: US 2007/0181508 A1
(43) Pub. Date: Aug. 9, 2007

(54) Photocatalytic fluid purification systems and methods for purifying a fluid

(76) Inventors: John Yupeng Gui, Niskayuna, NY (US); John Patrick Lemmon, Schoharie, NY (US); Larry Neil Lewis, Scotia, NY (US); Anil Raj Duggal, Niskayuna, NY (US); Venkatesan Manivannan, Rexford, NY (US); Jie Liu, Niskayuna, NY (US); Frank John Mondello, Niskayuna, NY (US)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 11/479,329

(22) Filed: Jun. 30, 2006

Related U.S. Application Data
(60) Provisional application No. 60/771,674, filed on Feb. 9, 2006.

(51) Int. Cl. C02F 1/32

(52) U.S. Cl. 210/748

(57) ABSTRACT

A conformable air purification system and methods generally includes optically coupling an active coating comprising a photocatalyst material with a flexible organic light emitting device (OLED) and configuring the flexible media into a desired shape that defines the fluid passageways of then system. The organic light emitting device can be selected to emit light in the visible range when low band gap photocatalyst materials are employed.

### CROSS REFERENCE TO RELATED APPLICATIONS

This application relates to and claims the benefit of U.S. Provisional Application No. 60/771,674, filed on Feb. 9, 2006 and incorporated herein by reference in its entirety.

### BACKGROUND

The present disclosure is generally directed to photocatalytic purification systems and more particularly, to conformable filterless fluid purification systems employing organic light emitting devices and low band gap photocatalytic materials.

Current filterless air purification devices are generally based on ultra violet (UV) photocatalysis. In these systems, UV light is exposed onto a catalytic surface generally composed of a titanium oxide (TiO₂) surface coating to create chemical reactions that convert target substances in fluids that pass through the device into less harmful substances such as carbon dioxide and water. The catalytic surface is generally a pleated surface having catalyst material coated thereon or impregnated therein. A UV lamp is disposed in close proximity to the catalytic surface such that fluid flows between the UV light source and the catalytic surface. Typically, these devices are bulky, heavy, rigid, expensive and/or inefficient to enable widespread use. As a result, most building and military installation air circulation systems are not adequately protected by an air purification system capable of destroying chemical and biological agents. Moreover, the effectiveness of the system typically decreases since the UV light source generally degrades over time. Moreover, the emitted UV light can degrade the filter media and other components of the air cleaner. Furthermore, UV light poses human health risks. For example, exposure to UV light in a residential purification device can cause severe damage to children's eyes.

Given that harmful agents may be released anywhere—on the battlefield or at home—there is a need for a portable and low cost air purification system that can be easily and readily implemented for new applications, as well as retrofitted for existing installations. With increased threats of bio-terrorism and infectious disease, there is a need to develop a low cost, portable, and conformable air purification system for homes and offices, as well as military hardware, such as ships, tanks, aircraft, and personnel tents. The above applications prefer a filterless filtration system because it needs low air pressure drop that can accommodate almost all existing air circulation systems or demand low power consumption for military applications.

Accordingly, there is a need for flexible, lightweight, filterless photocatalysis purification systems that can be readily conformable to the environment in which it is to be used.

### BRIEF SUMMARY

Disclosed herein are fluid purification systems and methods of purifying a fluid. In one embodiment, a fluid purification device for purifying a fluid comprises a flexible lighting substrate adapted to emit visible light, and an optically coupled photocatalyst layer.

In another embodiment, the fluid purification system comprises a housing having an inlet and an outlet; one or more fluid passageways disposed in the housing, each one of the one or more fluid passageways comprising a flexible substrate, a hermetically sealed flexible organic light emitting device layer disposed on the flexible substrate, and a flexible photocatalyst layer optically coupled to the organic light emitting diode layer, wherein the photocatalyst layer is configured to contact a fluid flowing through the fluid passageway; and a power source in electrical communication with the electrodes of the organic light emitting device layer.

In another embodiment, the fluid purification system comprises a first component comprising a flexible substrate having a flexible OLED structure disposed thereon: a second component spaced apart from the first component, the second component comprising a photocatalyst layer disposed on a surface of a substrate and a flexible OLED structure disposed on an opposite surface of the flexible substrate, wherein the photocatalyst layer is facing and in optical communication with the flexible OLED structure of the first component; and a third component spaced apart from the second component, the third component comprising a flexible substrate having a photocatalyst layer disposed thereon, wherein the photocatalyst layer is facing and in optical communication with the flexible OLED structure of the second component.

A method for purifying a fluid comprises flowing a fluid into a fluid passageway, the fluid passageway comprising flowing a fluid into a fluid passageway, the fluid passageway comprising a flexible substrate, a flexible organic light emitting device disposed on the flexible substrate, and a flexible photocatalyst layer optically coupled to the organic light emitting device, wherein the photocatalyst layer is configured to contact the fluid flowing through the fluid passageway and a power source in electrical communication with the electrodes of the organic light emitting device; and simultaneously emitting light from the organic light emitting device during the flowing of fluid into the fluid passageway.

The above described and other features are exemplified by the following figures and detailed description

### BRIEF DESCRIPTION OF THE DRAWINGS

Refer now to the figures, which are exemplary embodiments, and wherein the like elements are numbered alike.

FIG. 1 is a partial perspective view illustrating a plurality of fluid passageways for a conformable air purification device;

FIG. 2 is a partial cross-sectional view of an exemplary conformable air purification device;

FIG. 3 is a cross-sectional view of a fluid passageway structure in accordance with one embodiment and for use in the conformable purification system;

FIG. 4 is a cross-sectional view of an exemplary organic light emitting device structure suitable for use in the conformable air purification system of the present disclosure; and

FIG. 5 is a cross-sectional view of a fluid passageway structure in accordance with another embodiment and for use in the conformable purification system.

### DETAILED DESCRIPTION

The present disclosure is directed to conformable filterless air purification systems and methods for purifying a fluid. Briefly stated, it has been discovered that optically coupling an active coating comprising a low band gap photocatalyst material with a flexible organic light emitting device (OLED) allows conversion of fluid contaminants by photocatalytic reaction over a much larger surface area than is possible with traditional light sources and traditional photocatalysts such as the ones noted in the background section. In one embodiment, the structure of the optically coupled low band gap photocatalyst material and the OLED is flexible and reconfigurable. That is, the system can be made to conform to the particular end use. Advantageously, the photocatalyst covered flexible OLEDs enable the use of media having high catalytic surface areas with minimal reduction in fluid flow. Moreover, the resulting structure can be portable, compact, lightweight, and can be conformed for the desired application.

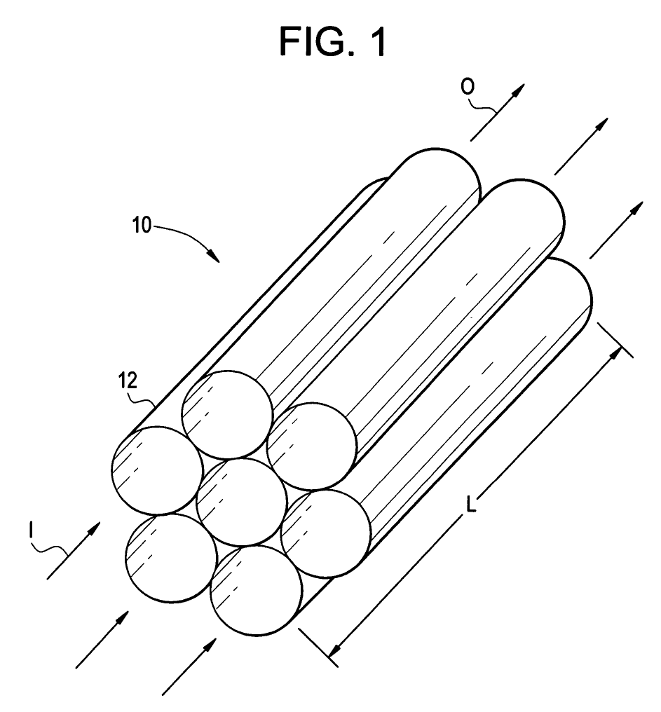

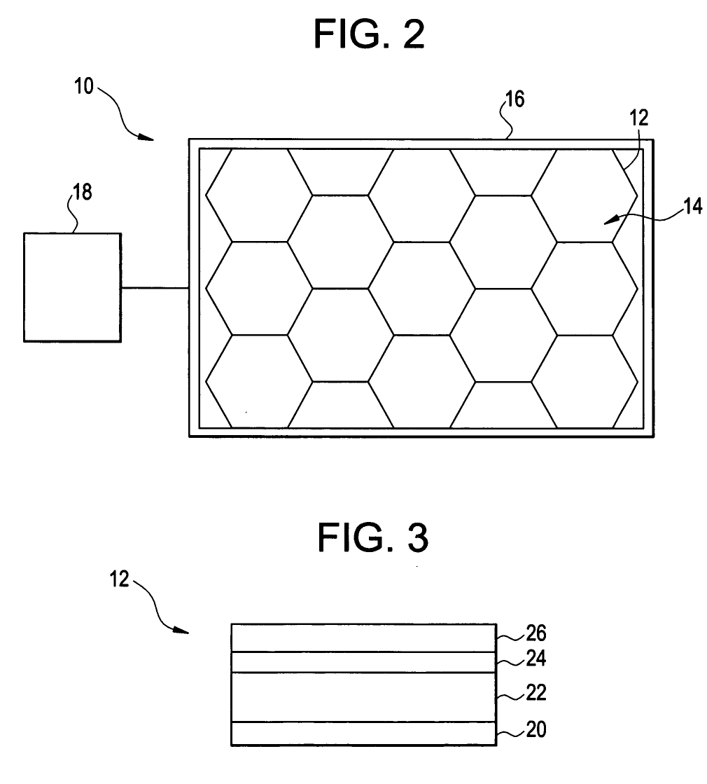

Referring now to FIGS. 1-3, an exemplary conformable air purification system generally designated by reference numeral 10 is illustrated. In FIG. 1 a partial perspective view of a plurality of fluid passageways 12 that define the air purification system are illustrated. Each fluid passageway is defined by a photocatalyst covered flexible OLED configured to have a cross sectional suitable for the intended application. The flexible OLEDs can conform to virtually any shape such as the circular cross sectional shape as shown in FIG. 1 or the hexagonal shape shown in FIG. 2. Other shapes includes various geometric shapes including, but not limited to, start shapes, ellipsoids, pentagonal, square, heptagonal, triangular, and the like. Other will be apparent to those skilled in the art in view of this disclosure. Moreover, it should be noted that depending on the application, the system could include uniform cross sectional shapes of the same or different sizes or may include dissimilar cross sectional shapes. The cross sectional opening of the fluid passageway will generally depend on the structure of the OLED and photocatalysts including such factors such as thicknesses and materials employed. The air purification system generally includes an inlet for fluid entering the system as indicated by arrow I and an outlet for purified fluid exiting the system. The length (L) of the fluid passageway will generally depend on the efficiency of the system, the rate of fluid flow, surface area, and desired residence times. Likewise, the number of individual fluid passageways will generally depend on the application, e.g., size constraints.

As shown more clearly in FIGS. 2 and 3, the system 10 generally includes an open celled matrix 14 of the fluid passageways 12 mounted within a housing 16. Each fluid passageway 12 is formed by optically coupling a low band gap photocatalyst material with a flexible OLED and shaping this to the desired filter configuration. In FIG. 2 as shown, a hexagonally shaped matrix 14 is illustrated. As shown more clearly in FIG. 3, the fluid passageway 12 comprises multiple layers and generally includes a flexible substrate 20 to which an OLED structure 22 is coupled thereto. A transparent or substantially transparent flexible layer 24 is disposed on the OLED layer to hermetically seal the OLED layer. The flexible transparent substrate 24 is coupled to flexible OLED layer 20 such that the photocatalyst 26 is in optical communication with light emitted from the OLED layer 22. The photocatalyst layer 26 is shown disposed on the transparent layer 24. A power source 18 (shown in FIG. 2) is in electrical communication with corresponding electrodes of the OLED structure 22. The entire structure is then formed into a fluid passageway such that the photocatalyst layer faces inward and is in direct contact with then fluid flow. The system may further include a controller for controlling the operation of the system.

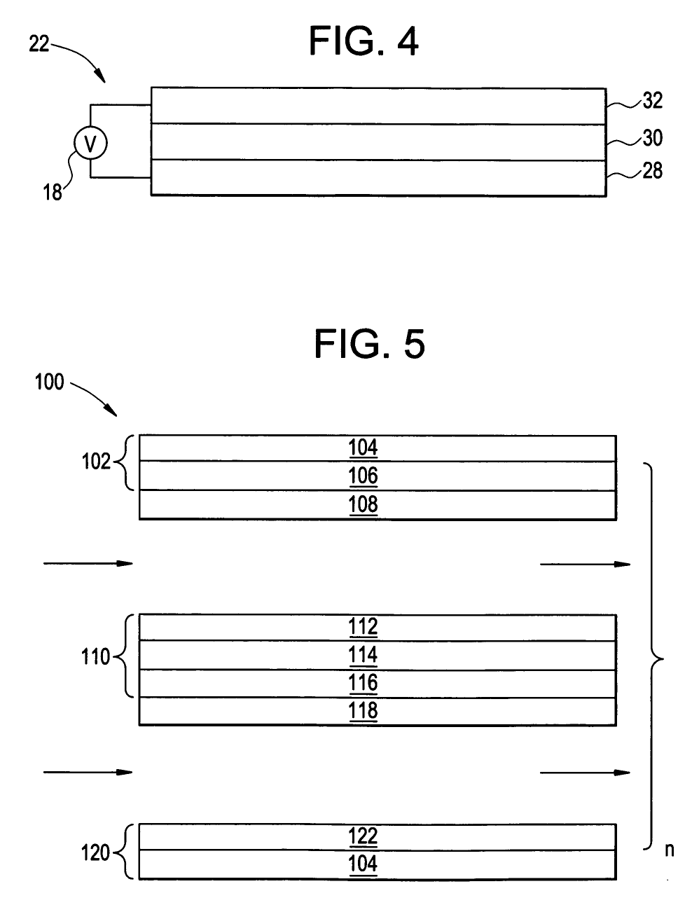

FIG. 4 illustrates a cross section of an exemplary flexible OLED structure 22. The OLED structure generally includes one or more organic layers 30 (for simplification only one is shown) sandwiched between two electrodes layers 28, 32 and is structured to be area scaleable, mechanically flexible, and conformable to any surface. The organic layers 30 include an electroluminescent material, which refers to the basic light-producing unit of the conformable air purification device 10. The organic layers can be formed of small molecules or polymers. Derivatives of poly(p-phenylene vinylene) and poly(fluorene) are commonly used as suitable suitable polymer luminophores in OLEDs. The organic layers can be deposited by a variety of means including, but not limited to techniques such as, vacuum deposition, organic phase deposition, inkjet printing, screen printing, gravure printing, spin-coating and the like. Indium tin oxide is a common transparent anode, while aluminum or calcium are common cathode materials. Other materials can be added between the emissive layer and the cathode or the anode to facilitate or hinder hole or electron injection, thereby enhancing the OLED efficiency. One of skill in the art will appreciate that the present disclosure is not limited to any particular OLED structure.

FIG. 5 illustrates a fluid passageway structure 100 in accordance with another embodiment. The fluid passageway structure 100 includes a sandwich arrangement that provides multiple passages. The sandwish arrangement can be repeated as many times (n) as desired. A first component 102 comprises a flexible metal substrate 104 to which layer 106 containing the OLED is disposed. A transparent layer 108 is disposed onto the OLED structure. A second component 110 is spaced apart from the first component 102 and is in optical communication with the OLED structure 106. The second component 110 includes a photocatalyst layer 112 facing the transparent layer 108 of the first component 102. The photocatalyst layer is disposed in a flexible metal substrate 114 to which a layer 116 of a second OLED structure and a second transparent layer 118 are disposed on the opposite side. The second component is spaced apart from a third component 120. The third component 120 has a second photocatalyst layer 122 disposed thereon and in optical communication with the OLED structure of the second component 110. It should be noted that the various photocatalysts can be of the same or of different materials. Likewise, the OLED structures of the first and second components can be configured to emit the same or different wavelengths of light depending on the intended application. Air flows through the fluid passageway 100 as indicated by the arrows and is subsequently purified.

The light-emitting organic materials can be chosen to emit a desired light spectrum for the intended application. In other words, the OLED emission spectrum can be tuned to kill multiple particulates and pathogens. The selection of a suitable organic material for the organic layer 30 that produces a wavelength is well within the skill of those in the art. The present disclosure is not intended to be limited to any particular organic electroluminescent material.

The OLED 22 operates under the principle of electroluminescence. That is, when a bias voltage 18 is applied across the electrodes 28, 32, light is generated within the organic material layer 30 and, assuming that at least one electrode is partially transmissive, emitted out of the structure through the transparent layer. As previously noted, the color of generated light can be readily tuned by using different organic materials. In fact, the number of possible organic molecules, each with tunable functions that can be utilized is virtually unlimited due to the capabilities of modern organic chemistry. The OLED structure may further include barrier layers to prevent moisture and air from interacting with the organic material layer since it has been found that moisture and air can cause deliquescence to the electroluminescent element, e.g., the organic layer 30. Suitable materials for forming the barrier layers are also within the skill of those in the art and can be used to function as transparent layer 24, if desired. Exemplary materials include, but are not limited to, organic coatings, inorganic coatings, organic hybrid coatings, inorganic hybrid coatings, and metal foils, for example. Organic coating materials may comprise carbon, hydrogen, oxygen and optionally, other minor elements, such as sulfur, nitrogen, silicon, etc., depending on the types of reactants. Suitable reactants that result in organic compositions in the coating are straight or branched alkanes, alkenes, alkynes, alcohols, aldehydes, ethers, alkylene oxides, aromatics, etc., having up to 15 carbon atoms. Inorganic and ceramic coating materials typically comprise oxide, nitride, carbide, boride, oxynitride, oxycarbide, or combinations thereof of elements of Groups IIA, IIIA, IVA, VA, VIA, VIIA, IB, and IIB; metals of Groups IIIB, IVB, and VB, and rare-earth metals. For example, silicon carbide can be deposited onto a substrate by recombination of plasmas generated from silane (SiH₄) and an organic material, such as methane or xylene. Silicon oxycarbide can be deposited from plasmas generated from silane, methane, and oxygen or silane and propylene oxide. Silicon oxycarbide also can be deposited from plasmas generated from organosilicone precursors, such as tetraethoxysilane (TEOS), hexamethyldisiloxane (HMDSO), hexamethyldisilazane (HMDSN), or octamethylcyclotetrasiloxane (D4). Silicon nitride can be deposited from plasmas generated from silane and ammonia. Aluminum oxycarbonitride can be deposited from a plasma generated from a mixture of aluminum titrate and ammonia. Other combinations of reactants, such as metal oxides, metal nitrides, metal oxynitrides, silicon oxide, silicon nitride, silicon oxynitrides may be chosen to obtain a desired coating composition. Further, the barrier layer may comprise hybrid organic/inorganic materials or multilayer organic/inorganic materials. The organic materials may comprise acrylates, epoxies, epoxyamines, xylenes, siloxanes, silicones, etc. The choice of the particular reactants can be appreciated by those skilled in the art.

In addition to the hermetic layer, it is preferred that the substrate 20 function as a non-active hermetic barrier support layer to effectively keep water and oxygen from getting into flexible OLED layer 22. The substrate 20 is flexible and can be any polymer substrate with barrier properties suitable for use with OLEDs, for example, a high heat polycarbonate film. Furthermore, the substrate 20 is structured to flex with OLED layer 22, providing for conformable excitation for photocatalyst 26. Application of the substrate 20 to the OLED layer 22 can be a direct thin-film encapsulation of the ultra-high barrier polymer to the OLED, or encapsulation of the OLED using barrier-coated plastic films with an adhesive encapsulant.

The transparent layer 24 is structured to be a non-active barrier support layer, similar to flexible back substrate 12 and as previously discussed can function as a hermetic layer if so desired. The transparent layer 24 is preferably a light-transmissive material that is structured to allow the flexible OLED layer 22 to be in optical proximity and communication with photocatalyst layer 26.

The photocatalyst layer 26 can be any suitable semiconductor photocatalyst that can be activated by flexible OLED layer 14. In one embodiment, the photocatalyst is a low band gap material such that photocatalysis can occur within the visible spectrum of rather than UV light. In one embodiment, the band gap is selected to be less than 3.2 electron volts (eV), and in other embodiments less than 3.0 eV, and in still other embodiments less than 2.8 eV. The corresponding emission spectra is preferably in the greater than about 390 nanometers, and in other embodiments is from about 400 nm to about 500 nm (443 nm corresponds to a band gap of 2.8 eV)

Suitable photocatalyst materials include, but are not intended to be limited to, SrTiO₃, TiO₂, ZnO, SnO₂, WO₃, Fe₂O₃ and Bi₂O₃ as well as mixtures thereof. The preferred photocatalyst material is the anatase form of TiO₂. Additives can also be added to the photocatalyst layer such as may be desired for different applications. For example, silver could be added to increase antibacterial activity in low light applications or in configurations wherein optical efficiency between the OLED layer and the photocatalyst is less than ideal. Other additives include zinc, copper, and the like. In addition, the size and shape can be varied as may be desired for the particular application.

The photocatalytic layer comprises of 10 wt % to 90 wt % of photocatalyst material and 90 wt % to 10 wt % binder having a higher bonding energy than the photocatalyst. Selection of binders, e.g., polymers, will be mainly based on enhancing the adhesive properties between the photocatalyst layer 26 and said transparent layer 24.

The low band gap photocatalyst materials, e.g., titanium dioxide, can be made through chemical modification, physical modification or a combination of both. Using titanium dioxide as an example, chemical modification can be achieved through doping wide band gap titanium dioxide with a transition metal cation and non-metal elements, such as nitrogen, fluorine, sulfur or carbon. Such doping can extend the photocatalytic activity of the titanium dioxide from the ultraviolet to the visible-light range because of the significant reduction in optical band gap. The band-gap reduction of the titanium dioxide can specifically occur through the partial substitution of oxygen with carbon, nitrogen, fluorine, sulfur and phosphorus. The partial substitution is preferably done with nitrogen. Physical modification of the wide band gap titanium dioxide can be accomplished by surface nanostructuring and Expanding Thermal Plasma (ETP) deposition. The nanostructured titanium dioxide film has reduced optical band gap through stress-induced property.

Hydrothermal synthesis is particularly attractive because it permits preliminary high temperature processing to produce crystalline titania before application to a temperature-sensitive plastic substrate. An example of a two-step synthesis is shown below, wherein a “paste” is formed in the first step and contains crystalline anatase. In the second step, colloidal solutions are produced as shown.

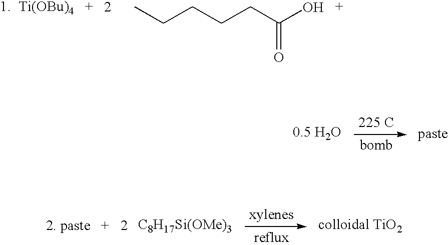

The structure of the carboxylic acid shown in step 1 can be varied to make and stabilize the titania. Processable composites can be prepared using thermoplastics or other plastic materials with the hydrothermally derived titania. The resulting titania plastic composite offers increased efficiency for light absorbance and bacterial destruction. In addition, the surface groups on the titania can be readily modified and optimized for the particular application. For example, improved attachment of bacteria can be obtained by employing a surface functionality that resembles that of the bacterial cell. Such a surface, typically composed of polysaccharides and phospholipids can be attracted using hydrophilic groups in the process for preparing the titania.

In operation, a method of using a conformable air purification system may comprise, e.g., providing an enclosure 16 having a fluid inlet “I” and a fluid outlet “O” (see FIGS. 1 and 2). When a fluid stream passes through conformable air purification device 26 it is exposed to the OLED light-activated photocatalyst surfaces. The activated photocatalyst surface captures and destroys any particulates and harmful agents in the fluid stream.

Advantageously, as mentioned above, the devices and systems of purification disclosed herein may allow for a reduction in production and installation cost and increased operating life over existing air purification systems, which use filters or rigid UV photocatalysis systems. More particularly, the conformable air purification device may be suitable for a greater range of potential applications because the conformable, lightweight nature of the device makes it useful for remote and field installations, as well as retrofit installation of existing ventilation systems. Additionally, use of flexible OLEDs with low band gap photocatalyst allows the use of plane light sources (i.e., numerous diodes), while existing UV photocatalysis systems only have single or few light tubes.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A fluid purification device for purifying a fluid, the device comprising:
a flexible lighting substrate adapted to emit visible light, and an optically coupled photocatalyst layer.

2. The fluid purification device of claim 1, wherein the flexible lighting substrate is selected from a group consisting of a light emitting diode, an organic light emitting diode, a waveguide sheet, an optical fiber, and combinations thereof.

3. The purification device in claim 1, wherein the device is flexibly configured to form a shape selected from a group consisting of a sheet, a rod, and a cylinder.

4. A fluid purification system for purifying a fluid, comprising:
one or more fluid passageways, each one of the one or more fluid passageways comprising a flexible substrate, a flexible organic light emitting device disposed on the flexible substrate, and a flexible photocatalyst layer optically coupled to the organic light emitting device, wherein the photocatalyst layer is configured to contact a fluid flowing through the fluid passageway; and
a power source in electrical communication with the electrodes of the organic light emitting device.

5. The fluid purification system of claim 4, wherein the photocatalyst layer contains a photocatalyst material selected from a group of semiconductors consisting of SrTiO₃, TiO₂, ZnO, SnO₂, WO₃, Fe₂O₃ and Bi₂O₃ and mixtures thereof.

6. The fluid purification system of claim 4, wherein said photocatalyst layer comprises a photocatalyst material having a band gap energy less than 3.0 eV.

7. The fluid purification system of claim 4, wherein said photocatalyst layer comprises a low band gap titanium dioxide photocatalyst material.

8. The fluid purification system of claim 4, wherein the photocatalyst layer comprises a photocatalyst material doped with one or more dopant materials effective to lower the band gap energy relative to an undoped photocatalyst material.

9. The fluid purification system of claim 4, wherein the flexible substrate further comprises a barrier layer selected to provide a permeation rate of water and oxygen less than 10⁻⁶ g/m²/day and 10⁻⁵ cc/m²/day, respectively.

10. The fluid purification system of claim 4, wherein said flexible substrate is a polycarbonate.

11. The fluid purification system of claim 4, wherein said flexible organic light emitting device emits light at wavelengths greater than 400 nanometers.

12. The fluid purification system of claim 4, wherein each one of the one or more fluid passageways has a cross sectional shape selected from a group consisting of circular, ellipsoid, and geometrical.

13. The fluid purification system of claim 13, wherein the cross sectional shapes are different for each one of the one or more fluid passageways.

14. A fluid purification system comprising:
a first component comprising a substrate having a OLED structure disposed thereon:
a second component spaced apart from the first component, the second component comprising a photocatalyst layer disposed on a surface of a substrate and a flexible OLED structure disposed on an opposite surface of the substrate, wherein the photocatalyst layer is facing and in optical communication with the OLED structure of the first component; and
a third component spaced apart from the second component, the third component comprising a flexible substrate having a photocatalyst layer disposed thereon, wherein the photocatalyst layer is facing and in optical communication with the OLED structure of the second component.

16. The fluid purification system of claim 14, wherein the photocatalyst layer comprises a doped TiO₂ in a crystalline form having a band gap energy less than 3.2 eV.

17. The fluid purification system of claim 14, wherein the photocatalyst layer is nanostructured.

18. A method for purifying a fluid, comprising:
flowing a fluid into a fluid passageway, the fluid passageway comprising a flexible substrate, a flexible organic light emitting device disposed on the flexible substrate, and a flexible photocatalyst layer optically coupled to the organic light emitting device, wherein the photocatalyst layer is configured to contact the fluid flowing through the fluid passageway and a power source in electrical communication with the electrodes of the organic light emitting device; and
simultaneously emitting light from the organic light emitting device during the flowing of fluid into the fluid passageway.

19. The method of claim 18, wherein the emitting light is at a wavelength greater than 400 nanometers.

20. The method of claim 18, wherein the photocatalyst layer comprises TiO₂ having a band gap energy less than 3.2 eV.
